(19) United States
(12) Patent Application Publication
(10) Pub. No.: US 2005/0172541 A1
(43) Pub. Date: Aug. 11, 2005

(54) Live animal trap assembly and bucket combination

(76) Inventor: Jerry T. Brewer, Iron City, TN (US)

Correspondence Address: Curtis W Dodd, 2803 Bentley Street, Huntsville, AL, 35801, US

(21) Appl. No.: 11/051,206

(22) Filed: Feb. 5, 2005

Related U.S. Application Data
(60) Provisional application No. 60/542,135, filed on Feb. 5, 2004.

(51) Int. Cl. A01M 23/18

(52) U.S. Cl. 43/61

(57) ABSTRACT

A live animal trap is described that uses a bucket as an animal container. A trap assembly is attached to the open end of the bucket. The trap assembly has a frame with a pivotally mounted door that is released when a food reservoir is moved towards the open end of the bucket.

### CROSS-REFERENCE TO RELATED APPLICATIONS

This application is related to Brewer, U.S. Provisional Patent Application No. 60/542,135, entitled “Live Animal Trap Assembly and Bucket Combination” filed on Feb. 05, 2004 and is incorporated by reference herein, with priority claimed for all commonly disclosed subject matter.

### FIELD OF THE INVENTION

The present invention generally relates to the field of animal traps for live capture of animals.

### RELATED ART

Animal traps of various kinds have been used throughout the history of man. In recent years there has been an increased need for traps that are used to capture animals for relocation and other purposes. The description of one such trap is contained in U.S. Pat. No. 6,609,327, issued Aug. 26, 2003 of Stoico. Other sources containing descriptions of animal traps include catalogs, manufacturer's literature, etc. that are available at sporting good stores and sports shows. The price of traps is variable, but it is desirable to keep the price as low as possible and at the same time still have a functional trap. The invention of Stoico has two doors, multiple actuation arms and springs and is fairly complex. Many of the traps in catalogs and at shows are complex and have a corresponding high cost. What is needed is a less expensive and less complex animal trap.

### SUMMARY OF THE DISCLOSURE

Generally, the present invention provides a new apparatus and method for combining an inexpensive conventional bucket with a novel attachable trap assembly. In one embodiment the trap assembly mounts to the bucket with screws or rivets. The trap assembly has a gravity-actuated door that is released by a trigger rod located within the bucket and extending through a frame. The bucket rests on its side and is partially supported by the trap assembly.

Various features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 illustrates an animal trap with a trap assembly coupled to a container.

FIG. 2 illustrates details of the trap assembly of FIG. 1.

FIG. 3 illustrates a bucket that is combined with the parts shown in FIG. 2 to form the animal trap of FIG. 1.

### DETAILED DESCRIPTION

The present invention generally pertains to animal traps and uses a conventional heavy-duty bucket or other container in combination with a trap assembly 100. The trap assembly may be fabricated with a variety of materials and is adapted to couple to a container such as a bucket as will be seen. In general, animal traps are dimensioned to correspond with the size of the animal to be trapped and a variety of baits may be used to attract the animal. Because a heavy-duty bucket, such as a high density polyethylene (“HDPE”) bucket, is generally inexpensive and tough enough to contain animals HDPE buckets are preferred as the container that is attached to the trap assembly of the present invention. Preferably the trap assembly is made of metal, chosen for high strength and low cost. Environmental factors must also be considered when selecting materials for the animal trap 100 described herein. For example, materials that are toxic or harmful in some way are considered undesirable. Any materials that have the strength and durability to contain an animal would fall within the scope of the present invention. Containers may have a variety of shapes, such as a cylindrical shape, a rectangular shape, and other known shapes.

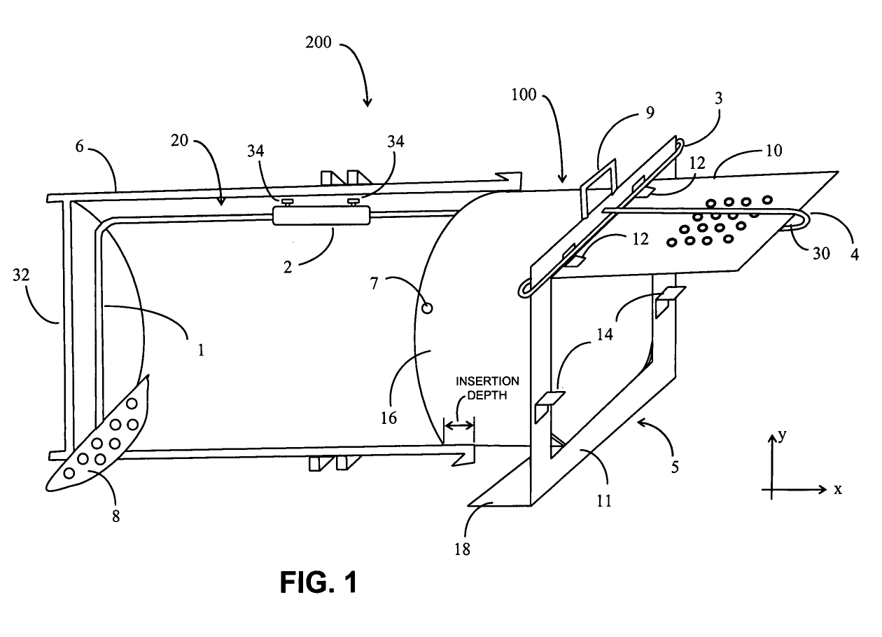

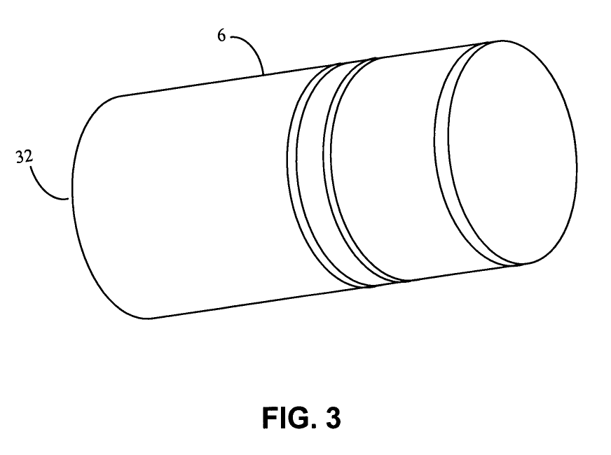

Referring to FIG. 1 there is shown an animal trap 200 comprised of a bucket 6 and a trap assembly 100. The bucket 6 is shown with part of its side removed for illustration purposes. The bucket 6 may be viewed more clearly in FIG. 3. The trap assembly 100 is attached to the bucket 6 and is comprised of a door assembly 5 and a rod assembly 20 as illustrated in FIG. 1.

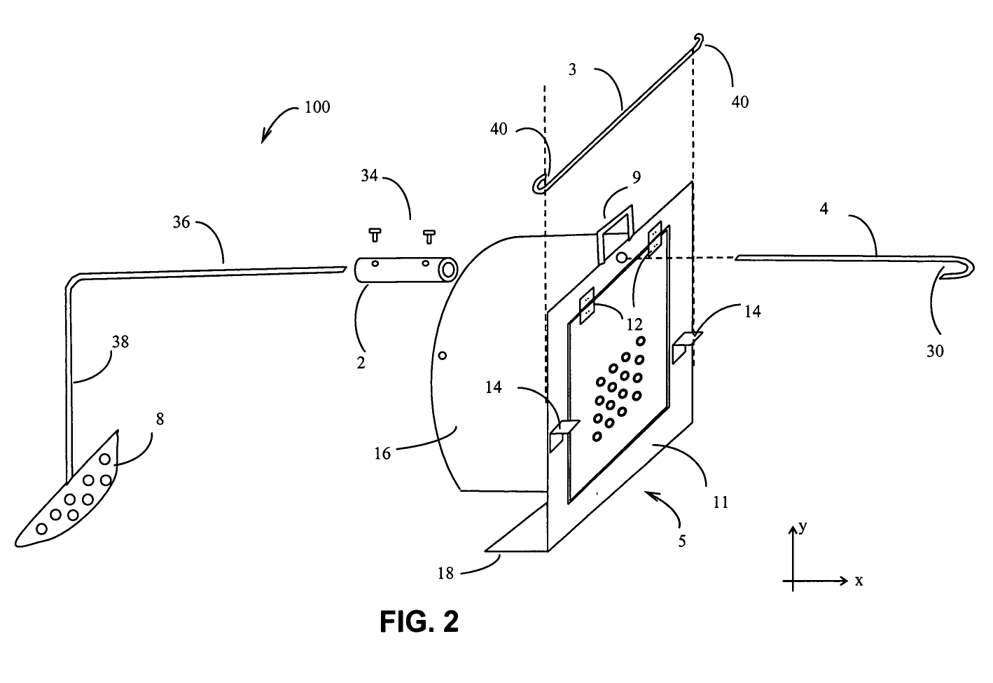

In one embodiment the door assembly 5 has a door 10 attached to a frame 11 with hinges 12. The door 10, when not held in place by rod assembly 20, may pivot between a horizontal position (the open position) as shown in FIG. 1 and a vertical position (the closed position) as shown in FIG. 2. The frame 11 has an opening, preferably with a square shape, that is dimensioned slightly larger than the door 10 so that when the door is in the closed position it fits within the frame opening. Preferably the door has perforations, sized to allow fresh air in and small enough keep an animal contained. The frame 11 in one embodiment has a foot 18 on its bottom edge that rests on the ground and provides a stabilizing support for the animal trap 200.

The door 10 of the door assembly 5 is shown in a horizontal or open position and is held in the open position by a hook 30, generally J-shaped, on one end of a support rod 4. The door is typically in either a fully open position as shown in FIG. 1 or in a fully closed position as shown in FIG. 2. A carrying handle 9 is attached to the top edge of the frame 11.

Still referring to FIG. 1, a door lock bar 3 is shown near the top of the frame 11 and positioned under the support rod 4. When the support rod 4 is moved in the x-direction (horizontally outward) the hook 30 of the support rod 4 no longer supports the door and gravity causes the door 10 to drop or swing down to the closed position. When the door 10 is in the closed position, gravity also pulls the lock bar 3 downward until it rests against bar stops 14. The bar stops 14 limit the vertical drop of the lock bar 3 and thereby allow the lock bar to stay in a position that holds the door 10 closed. When the door 10 is closed and secured by the lock bar 3, an animal is securely contained within the animal trap 200. In one embodiment, the lock bar 3 and the bar stop 14 are attached together (when the door 10 is closed) with ties, twisted wire or some other well-known reversible connector. The handle 9 on the top of the door assembly 5 is provided as a grip for carrying the animal trap 200. The door assembly 5 is preferably attached to the bucket 9 by screws, rivets, or other well-known means using the holes 7 on a flange 16. The flange 16 extends horizontally from the back of the frame 11 (in the negative x-direction). The flange 16 preferably is dimensioned to fit snuggly within interior walls of the bucket 9 or other shaped container.

The rod assembly 20 is used to hold the door open using the hook on one end of the support rod 4. The rod assembly 20 comprises the support rod 4, an adjustment tube 2 and a trigger rod 1. The trigger rod 1 is essentially L-shaped with one arm of the L oriented horizontally and the other arm oriented vertically. The adjustment tube 2 connects the support rod 4 to the trigger rod 1 with set screws. The adjustment tube 2 is a hollow cylinder whose interior diameter is dimensioned to accept one end of the support rod 4 and one end of the trigger rod 1. The set screws extending with in the adjustment tube allow for adjustment of the horizontal length of the rod assembly as would be understood by those skilled in the art.

A food reservoir 8 is attached to the bottom end of the vertical leg of the trigger rod 1. The food reservoir 8 holds bait to attract an animal and is dimensioned and shaped to move along the downward side of the bucket 9. Preferably, the food reservoir 8 has a radius on its bottom edge that is about the same as the radius of the bucket 6. When an animal enters the animal trap and pulls or moves the food reservoir 8 in the x-direction (outward direction) thereby moving the rod assembly 20, the hook on the support rod 4 no longer supports the door 10. When the door 10 pivots to a vertical position as seen in FIG. 2 then the door lock bar 3 drops downward thereby securing the door 10 in the closed position as described above.

Details of the door assembly 5 and the rod assembly 20 are shown more clearly in FIG. 2. In FIG. 2, the door 10 is shown in the closed position. The lock bar 3 preferably is a rod with a channel 40 on each end. In one embodiment, as shown, the channels 40 are formed by bending J-shapes in each end of the lock bar 3. The channels are dimensioned to allow the lock bar 3 to slide freely up and down the vertical outside edges of the frame 11. It is generally desirable that the lock bar 3 only be removable when pushed upward beyond the top edge of the frame 11. The bar stops 14 prevent removal of the lock bar 40 from the bottom of the frame 11.

It should be further emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A trap assembly coupled to a container and providing an animal triggered and gravity actuated animal trap, the trap assembly comprising:
a door assembly having a door pivotally mounted to a frame where the door fits within an opening in the frame when the door is closed, the frame further having a coupling for attaching the door assembly to the container and a lock bar with channels adapted to fit about vertical edges of the frame and extend across the front of the frame; and
a rod assembly with a hook on one end for holding the door open and wherein the door to closes when the hook is urged away from the bottom edge of the door, the rod assembly extending through the frame and within the container wherein the other end of the rod assembly has a movable food reservoir.

2. The trap assembly of claim 1 wherein the container that is a bucket.

3. The trap assembly of claim 1 wherein the frame has bar stops for limiting the vertical drop of the lock bar.

4. The trap assembly of claim 1 wherein the rod assembly is comprised of a straight rod with the hook coupled to an L-shaped rod with a length adjustment tube.

5. The trap assembly of claim 4 wherein an outward movement the food reservoir releases the door.

6. The trap assembly claim 1 wherein the container has a rectangular shape.

7. The trap assembly of claim 3 wherein the bar stops and the lock bar are attached together when the door is closed.

8. The trap assembly of claim 1 wherein a carrying handle is attached to the frame.

9. The trap assembly of claim 2 wherein the frame has foot for stabilizing the bucket.

10. An animal trap comprising:
a container having an open end;
a frame with an opening for allowing an animal to enter the container at the open end, the frame positioned vertically and attached to the open end of the container;
a door that fits within the frame opening and is pivotally mounted to an edge of the opening near the top of the frame;
a rod assembly with a hook for holding the door open when the trap is set and for releasing the door when the trap is triggered, the rod assembly extending through the frame and within the container.

11. The trap of claim 10 wherein the container is shaped like a bucket.

12. The trap of claim 11 wherein the container is square with a closed end and an open end.

13. The trap of claim 10 wherein a lock bar is coupled between outside vertical edges of the frame and drops vertically downward when the trap is triggered, thereby holding the door in a closed position.

14. The trap of claim 13 wherein the frame has bar stops for limiting the vertical drop of the door lock bar.

15. The trap of claim 10 wherein the frame has a foot for stabilizing the the trap.

16. An animal trap for trapping live animals, the trap comprising:
a container with an open end, a closed end and one or more sides;
a door assembly having a frame with an opening and a pivotally mounted door wherein the axis of the pivot is horizontal and near the top of the frame, wherein the door is approximately the size of the opening in the frame, the door assembly further having a trigger actuated latch for releasing the door to a closed position, the door assembly further having a flange that is attached to the sides of the container with fasteners;
a support rod with a hook on one end and a food reservoir on the other end, wherein movement of the food reservoir towards the open end of the container releases the door allowing the door to swing from a horizontal position to a vertical position.

17. The animal trap of claim 16 wherein the latch is a lock bar that slides across the door when the door is in the vertical position.

18. The animal trap of claim 16 wherein the container and the the flange are cylindrically shaped.

19. The animal trap of claim 16 wherein the support rod is comprised of a first bar with the hook, an adjustment tube for varying the length of the support rod, and an L-shaped bar that couples to the adjustment tube on one end and has a food reservoir on the other end.

20. The animal trap of claim 16 wherein the container is a bucket.
